(19) United States
(12) Patent Application Publication
(10) Pub. No.: US 2005/0286086 A1
(43) Pub. Date: Dec. 29, 2005

(54) Image output apparatus, output image control method, and output image control program

(75) Inventors: Naoki Takahashi, Kyotanabe-shi (JP); Kazumasa Hayashi, Kobe-shi (JP); Akinori Toyoda, Osaka (JP); Masao Ootsuka, Osaka (JP); Akinobu Okuda, Osaka (JP); Hideki Yasuda, Osaka (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/157,064

(22) Filed: Jun. 21, 2005

(30) Foreign Application Priority Data
Jun. 23, 2004 (JP) 2004-184739
Dec. 15, 2004 (JP) 2004-362641

(51) Int. Cl. G06K 15/00

(52) U.S. Cl. 358/3.26

(57) ABSTRACT

An image output apparatus for controlling an output image stably. The image output apparatus comprises a database for storing data giving a relation between manipulated variables and a controlled variable for a reference pattern. The apparatus estimates sets of values of the manipulated variables used when outputting an image of the reference pattern, by using the data on the database to obtain values of the manipulated variables from a desired value for the reference pattern. By means of detected values for a plurality of images of the reference pattern outputted according to the estimated values of the manipulated variables, set values of the manipulated variables for the desired value is calculated.

### BACKGROUND OF THE INVENTION

1. Field of the Invention

The present invention relates to an image forming apparatus like a copying machine, a facsimile machine, a printer, or a multifunction processing machine, and the other types of image output apparatus, and in particular, relates to a technique for controlling the quality of an output image according to a desired value.

2. Description of the Related Art

In the electrophotographic type of image forming apparatus, an image density is controlled by means of a density patch of an image formed on a paper or a toner image formed on a photoconductor. If the image density had not been controlled, the reproducibility of the image would have been spoiled due to the environmental conditions, and the aged deterioration of the apparatus. In general, the control of the image density is performed by detecting the density of the density patch, and making a feedback of the detected value. For instance, the image forming apparatus controls a grid voltage of a charger or a laser power of a laser output unit according to the detected value. However, it is hard to reduce the frequency of forming the density patch till the density converges on a desired scope, by the conventional method.

Japanese Laid-open Publication No. 10-63048 discloses an image forming apparatus in which the image density is controlled by past control case data. The control case data correlates values of state variables with values of manipulated variables and detected values for the density patches. The state variables indicate the temperature, the humidity, and so on. The state variables can be replaced with an occurrence time of the case. The manipulated variables indicate the grid voltage of the charger and the laser power of the laser output unit, for example. The density patches includes a solid density patch and a highlight density patch. The image forming apparatus detects the state variables when controlling the image density, and then extracts a control case for the detected values. By using the extracted control case, the density values of the both patches are controlled to desired values, respectively.

Each case can be illustrated by a point in a space CS of the control case as shown in FIG. 17, for example. When plural cases have no substantive changes of the state variables, those cases are handled as those forming a plane in the control case space CS. The plane can be defined by using at least three sets of values M1 to M3 of the manipulated variables on the values of the state variables that make no difference substantially. Since each case includes the detected values B1 to B3 and H1 to H3 of the density for two kinds of patches, FIG. 17 shows two case planes BP and HP for the two kinds of patches.

As shown in FIG. 18, the desired densities for the two kinds of patches are also given respectively by planes BTP and HTP. A line BTL of intersection of the case plane BP for the solid density and the desired density plane BTP for the solid density gives a set of values of the manipulated variables to materialize the desired density for the solid density. Also, a line HTL of intersection of the case plane HP for the highlight density and the desired density plane HTP for the highlight density gives a set of values of the manipulated variables to materialize the desired density for the highlight density. A point of intersection of the lines BTL and HTL projected on a plane formed by the grid voltage and the laser power, gives values of the manipulated variables to materialize the desired density for both the solid density and the highlight density.

By using the values thus obtained in order to operate the charger and the laser output unit, the image forming apparatus controls the image density. For the control of the image density, the image forming apparatus is required to prepare at least three sets of control cases according to the current state variables, so that the frequency of forming the density patch can be reduced as compared with the conventional method.

### SUMMARY OF THE INVENTION

However, the above-mentioned image forming apparatus is required to accumulate the control cases for various states. Since the values of the state variables change according to the environmental conditions like the temperature and the humidity, or the aged deterioration, during the running time of the apparatus, the control cases must be collected so as to correspond to those changes.

Additionally, there is a possibility that the plane defined by the three sets of cases does not represent an actual characteristic of the apparatus sufficiently. The characteristic of the image density for the manipulated variables do not always form a linear shape. In a complicated system like the electrophotography process, the image density changes non-linearly corresponding to the change of the state.

In result, if the three cases are not proper, the detachment between the plane defined by those cases and the essential non-linear characteristic become large. Hence, the control case plane and the desired density plane do not intersect each other within an adjustable range, which makes it difficult to control the image density.

Those problems might also occur in case where the same method controls the output image regarding a physical quantity different from the image density, such as the brightness, the hue, and the glossiness.

The present invention is for settling those conventional problems, and has an object to provide an image output apparatus, an image output control method, and an image output control program, those which can control the output image stably without storing a number of control cases during the operation time.

In the image output apparatus of the invention, an image output unit outputs an image according to values of manipulated variables. A detecting unit detects a controlled variable of an output image of a reference pattern. A data storing unit stores data giving a relation between the controlled variable and the manipulated variables for the reference pattern. A reference pattern output value estimating unit estimates sets of manipulated variables used when outputting images of the reference pattern, by using the data on the data storing unit to obtain values of the manipulated variables from a desired value for the reference pattern. A manipulated variable calculating unit calculates set values of the manipulated variables for the desired value, according to the detected values for a plurality of images of the reference pattern outputted by using the sets of the estimated values of the manipulated variables.

The manipulated variable calculating unit can obtain a linearized output characteristic according to the detected values for the plurality of images of the reference pattern and the values of the manipulated variables used when outputting respective images, and calculate the set values of the manipulated variables for the desired value, according to the linearized output characteristic.

The reference pattern output value estimating unit can obtain the values of the manipulated variables using the data on the data storing unit, by changing the values of the most dominant manipulated variable over the controlled variable, of the manipulated variables.

The reference pattern output value estimating unit can estimate the values of the manipulated variables used when outputting the image of the reference pattern, according to the set values of the manipulated variables and the values of the manipulated variables related to the controlled variable for the desired value.

The data storing unit is a database containing a plurality of records relating the value of the controlled variable to the values of the manipulated variables, for example. The reference pattern output value estimating unit can estimate the values of the manipulated variables used when outputting the image of the reference pattern, by obtaining the values of the manipulated variables related to the value of the controlled variable for the desired value, from the data on the database.

The image output apparatus may further comprise a data update unit for updating the data on the data storing unit, according to the detected value for the image of the reference pattern outputted according to the values of the manipulated variables obtained from the database.

The data update unit can set a range of the manipulated variables, according to an approximate difference when the relation between the controlled variable and the manipulated variables is linearized.

In the image output apparatus, the reference pattern output value estimating unit may calculate values of the manipulated variables predicted to be the optimum for adjusting the detected value for the output image of the reference pattern to the desired value, and obtain the values of the manipulated variables near to the calculated optimum predicted value by using the data on the data storing unit.

The manipulated variable calculating unit can calculate the set values of the manipulated variables for the desired value, according to the detected values for the plurality of images of the reference pattern outputted according to the set values of the manipulated variables and the values of the manipulated variables near to the optimum predicted value.

Another aspect of the invention is to provide an image forming apparatus. In the image forming apparatus, a charger charges a surface of a photoconductor uniformly. A laser output unit forms on the surface of the photoconductor an electrostatic latent image according to image signals, by exposing the uniformly charged surface of the photoconductor. A developing unit forms a toner image on the surface of the photoconductor, by developing the electrostatic latent image on the surface of the photoconductor with toner. A sensor detects the density of the toner image of a reference pattern formed on the surface of the photoconductor. A database stores data giving a relation between input values to the charger and the laser output unit and a value of the density for the reference pattern. A reference pattern output value estimating unit estimates sets of input values to the charger and the laser output unit used when forming toner images of the reference pattern, by using the data on the database to obtain values of the manipulated variables from a desired value of the density for the referenced pattern. A manipulated variable calculating unit calculates set values of the input values to the charger and the laser output unit used when forming the image, according to the detected values for the toner images of the reference pattern formed by the estimated input values to the charger and the laser power and the desired value.

In the image forming apparatus, the manipulated variable calculating unit can calculate the input value to the developing unit according to the input value to the charger.

The reference pattern output value estimating unit may estimate at least two sets of the input values to the charger and the laser output unit used when forming a solid density patch and a highlight density patch, according to the desired values of the density for respective the solid density patch and the highlight density patch.

The reference pattern output value estimating unit can select the input value to the laser output unit as a preferentially changed value when obtaining the input values to the charger and the laser output unit from the desired value of the density for the solid density patch, and select the input value to the charger as a preferentially changed value when obtaining the input values to the charger and the laser output unit from the desired value of the density for the highlight density patch.

The reference pattern output value estimating unit may specify a prediction line formed by predicted values of the manipulated variables for adjusting the density of the solid density patch to a desired density for the solid density patch, specify a prediction line formed by predicted values of the manipulated variables for adjusting the density of the highlight density patch to a desired density for the highlight density patch, and estimate the input values to the charger and the laser output unit used when forming the solid density patch and the highlight density patch by using the respective prediction lines for the solid density patch and the highlight density patch.

The reference pattern output value estimating unit estimates values of the manipulated variables predicted to be the optimum for adjusting the density of the solid density patch to the desired density of the solid density patch as well as for adjusting the density of the solid density patch to the desired density for the solid density patch, by using the respective prediction lines for the solid density patch and the highlight density patch, and obtains the values of the manipulated variables near to the calculated optimum predicted value by using the data on the database, whereby the reference pattern output value estimating unit estimates the input values to the charger and the laser output unit used when forming the solid density patch and the highlight density patch.

Further another aspect of the invention is to provide an output image control method for controlling an output image by using a reference pattern. The output image control method comprises the step of: calculating sets of values of manipulated variables used when outputting an image of a reference pattern, by obtaining the values of the manipulated variables from a desired value for the reference pattern using data on data storing unit storing the data giving a relation between the controlled variable and the manipulated variables for the reference pattern; outputting a plurality of images of the reference pattern according to the estimated values of the manipulated variables; and calculating set values of the manipulated variables for the desired density according to the detected value for the controlled variable of the output image of the reference pattern.

Still another aspect of the invention is to provide an output image control program for causing the image output apparatus to perform the steps of the above output image control method, and a machine readable medium bearing instructions of the output image control program.

By employing such configuration of the invention, the output image can be stably controlled without collecting a number of control cases during the operation time.

These and other objects, features, aspects and advantages of the present invention will become more apparent from the flowing detailed description of the present invention when taken in conjunctions with the accompanying drawings.

### BRIEF DESCRIPTION OF THE DRAWINGS

FIG. 1 is a diagram for a schematic configuration of an image forming apparatus in preferred embodiments of the invention.

FIG. 2 is a block diagram for a functional configuration in connection with the image density control of the image forming apparatus.

FIG. 3 is a diagram illustrating an example of a reference pattern.

FIGS. 4A and 4B are diagrams illustrating an example of a structure of an image density database.

FIG. 5 is a diagram illustrating an example of density values for solid density patches stored in the image density database.

FIG. 6 is a flowchart explaining steps of the output image control method in preferred embodiments of the invention.

FIG. 7 is a functional block diagram for another configuration of the image forming apparatus.

FIG. 8 is a flowchart explaining steps of the data update processing.

FIGS. 9A and 9B are diagrams explaining the planarity characteristic of the database.

FIGS. 10A and 10B are diagrams for another example of structure of the image density database.

FIG. 11 is a diagram explaining the interpolation calculation of the density.

FIG. 12 is a diagram explaining steps of specifying a prediction line.

FIG. 13 is a diagram explaining a relation between the prediction lines and an optimum predicted value.

FIG. 14 is a diagram explaining a relation between the optimum predicted value and a near value.

FIG. 15 is a flowchart explaining for another example of steps of the output image control method.

FIG. 16 is a diagram showing an example of the potential damping characteristic of a photoconductor.

FIG. 17 is a diagram illustrating a conventional image control method.

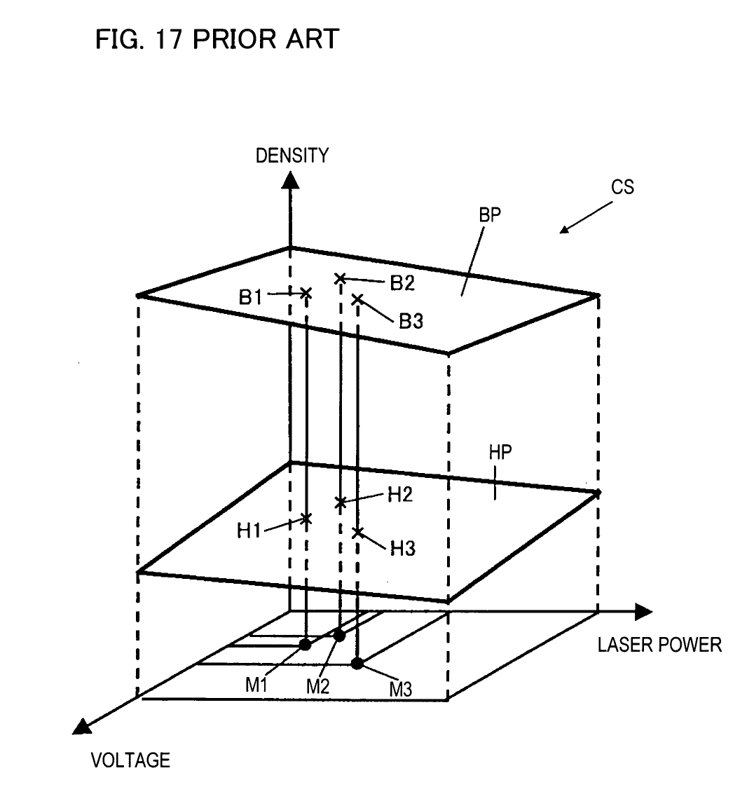

FIG. 18 is a diagram illustrating a conventional image control method.

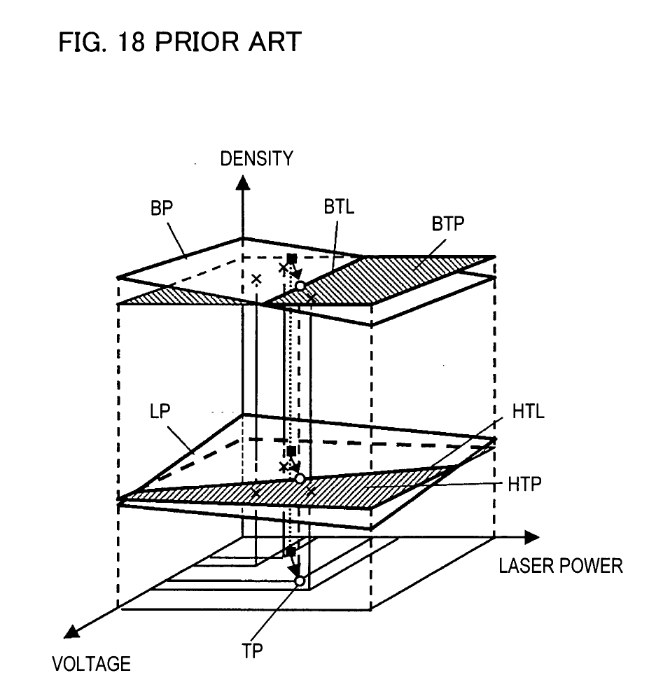

### DESCRIPTION OF THE PREFERRED EMBODIMENTS

In these embodiments, the invention is embodied as an electrophotographic type of image forming apparatus which controls the density of a toner image according to a given desired value to stabilize the image quality.

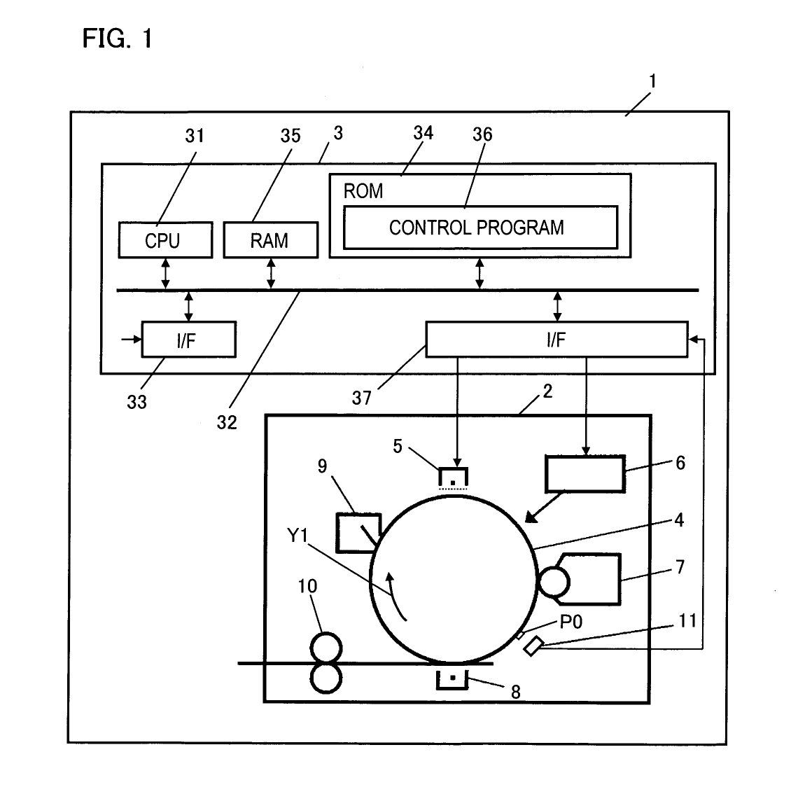

FIG. 1 is a diagram illustrating a schematic configuration of the image forming apparatus in the preferred embodiments of the invention. An image forming apparatus 1 comprises an image forming unit 2 and an image density control unit 3.

The image forming unit 2 forms a monochrome image for an input image signal on a paper in the electrophotographic process. The image forming unit 2 includes a photosensitive drum 4 which is rotatable toward a direction of an arrow Y1. Around the photosensitive drum 4, a scorotron charger 5, a laser output unit 6, a developing unit 7, a transfer unit 8, and a cleaner 9 are disposed, and a fixing unit 10 is placed on a carrying route for the paper.

The scorotron charger 5 uniformly charges a surface of the photosensitive drum 4. The laser output unit 6 irradiates a laser beam modulated according to the image signals, on the surface of the uniformly charged photosensitive drum 4. By the irradiation, an electrostatic latent image for the image signals is formed on the surface of the photosensitive drum 4.

The developing unit 7 develops the electrostatic latent image on the surface of the photosensitive drum 4 by putting toners on the electrostatic latent image using a developing roller. A one-component developing unit or two-component developing unit can be used for the developing unit 7. The one-component developing unit uses just toners as a developer. The one-component developing unit charges the toners by friction with a developing roller. Here, the two-component developing unit is used as the developing unit 7. The two-component developing unit uses an admixture of the toners and magnetic material carriers as a developer. When the developing unit 7 mixes the developer therein, the toners are charged by the mixing. Only the charged toners are put on the electrostatic latent image. In result, a visible toner image is formed on the surface of the photosensitive drum 4. If the proportion of the toner and the carrier changes due to the consumption of the toner, since this affects the image density, the toner must be refilled as needed, according to the consumed amount.

The transfer unit 8 transfers onto the paper the toner image formed on the surface of the photosensitive drum 4. The cleaner 9 removes residual toners on the surface of the photosensitive drum 4. The fixing unit 10 fixes the transferred image on the paper. According to the above processing, the image forming unit 2 forms on the paper the image for the image signals.

The image forming unit 2 further includes a density sensor 11. The sensor 11 is placed between the developing unit 7 and the transfer unit 8. The sensor 11 faces the surface of the photosensitive drum 4, and it can detect a density of a toner image formed on the surface of the photosensitive drum 4.

The image density control unit 3 controls the density of the toner image formed on the surface of the photosensitive drum 4 using the detected value of the sensor 11. As shown in FIG. 1, the image density control unit 3 is provided with CPU 31, and bus 32. The CPU 31 is connected with an interface circuit 33, a ROM 34, and a RAM 35 through the bus 32. The interface circuit 33 is a circuit through which the CPU 31 can exchange with the unillustrated other systems of the image forming apparatus 1. The ROM 34 stores a control program 36. The control program 36 is for giving instructions necessary for controlling the density of an output image, to the image forming apparatus 1. When the image forming apparatus 1 is powered on, the CPU 31 reads out the control program 36 from the ROM 34 and operates the control program 36 on the RAM 36. While exchanging with the other system through the interface circuit 33 as need arise, the CPU 31 controls the density of the image according to the instructions of the control program 36. And the bus 32 is also connected with an interface circuit 37. In controlling the image density, the CPU 31 obtains the detected value of the sensor 11, or gives set values to the charger 5 and the laser output unit 6, via the interface circuit 37.

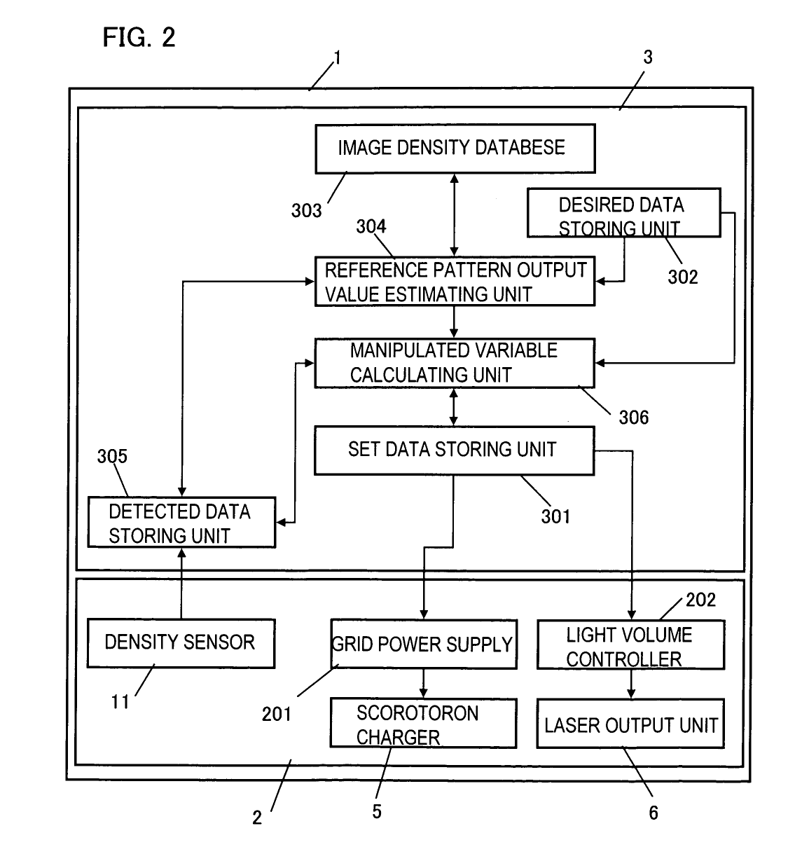

FIG. 2 is a block diagram for illustrating a functional configuration in connection with the image density control of the image forming apparatus in this embodiment. By working according to the instructions of the control program 36, the image density control unit 3 of the image forming apparatus 1 includes a set data storing unit 301, a desired data storing unit 302, an image density database 303, a reference pattern output value estimating unit 304, a detected data storing unit 305, and a manipulated variable calculating unit 306.

The set data storing unit 301 stores data of set values of the grid voltage applied to the scorotron charger 5 and the laser power for the laser output unit 6. The charger 5 is connected with a grid power supply 201, and the laser output unit 6 is connected with a light volume controller 202, as shown in FIG. 2. The grid power supply 201 applies the voltage for the set value obtained from the set data storing unit 301 on a grid of the charger 5. The light volume controller 202 adjusts the laser power of the laser output unit 6 according to the set value. In the embodiment, the image density control unit 3 controls the density of the image by using the value of the grid voltage and the value of the laser power as the manipulated variables.

The desired data storing unit 302 stores data of a desired density for a reference pattern. The data can be set to the apparatus by having been stored in the ROM 34 in advance. The setting may be adjusted according to an operator's instruction for the desired density by a dial or the like. The image density control unit 3 controls the image density by comparing the detected value of the sensor 11 for the output image of the reference pattern and the desired value. In the embodiment, the reference pattern is given as a patch for the solid density and a patch for the highlight density. The reason the above-mentioned two values are used as the manipulated variables is that the both manipulated variables generally have a high correlation with the solid and highlight density part. The desired density is prepared for each patch.

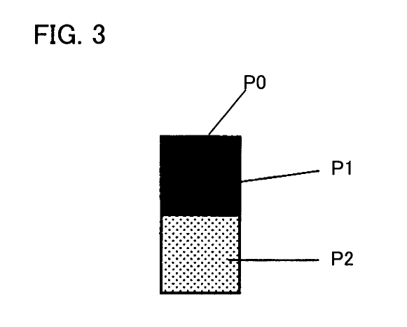

FIG. 3 is a diagram for illustrating an example of the reference pattern. A reference pattern P0 includes a solid density patch P1 and a highlight density patch P2 in the shape of rectangle. In this figure, the solid density patch P1 and the highlight density patch P2 are disposed above and below in this order. For instance, the solid density patch P1 is 100% of the coverage, while the highlight density patch P2 is 20% of the coverage. The image forming unit 2 forms both the patches P1 and P2 on the surface of the photosensitive drum 4. The number of patches having different density is not limited to two, but it may be three and more. Further, each patch may have another value of the coverage.

The image density database 303 stores data giving a relation between the manipulated variables and a controlled variable for the reference pattern. The data can be stored in the ROM 34 prior to shipment of the apparatus. Here, the image density database 303 contains records correlating the values of the controlled variable with the values of the manipulated variables.

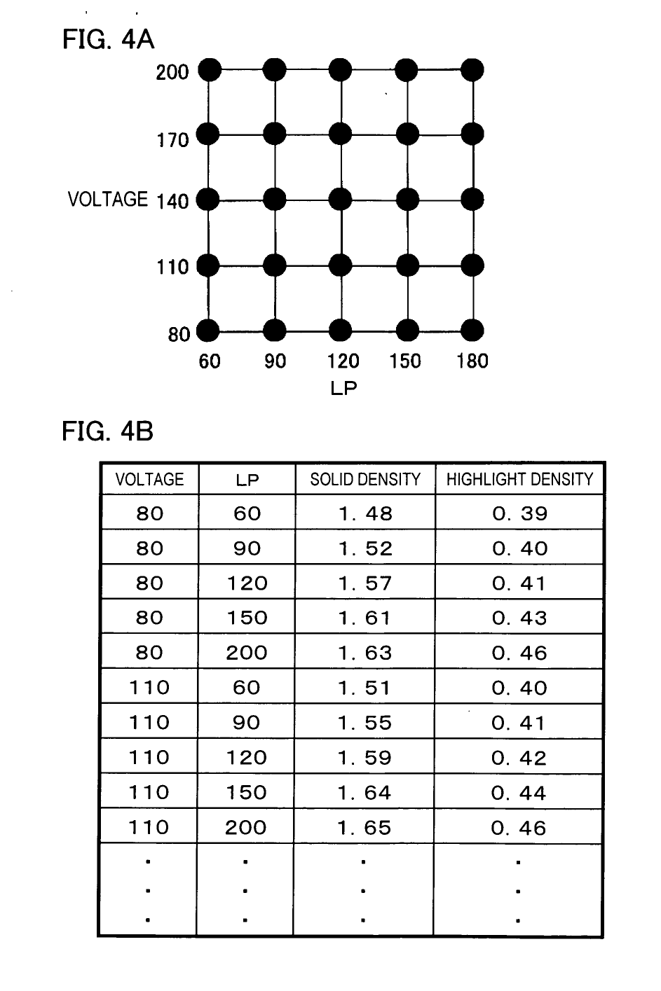

FIGS. 4A and 4B illustrate an example of a configuration of the image density database. FIG. 4A illustrates a plane formed by two manipulated variables. A horizontal axis represents the laser power, and a vertical axis represents the grid voltage. Lattice points (black spots) on the plane indicate respective records stored in the image density database 303. The respective records are data wherein each of the two manipulated variables is changed in a fixed interval. The example shows that the grid voltage and the laser power are indicated by values between 0 and 255, namely the grid voltage is indicated by values from 80 to 200, and the laser power is indicated by values from 60 to 180; and the data is prepared for every 30.

FIG. 4B shows a concrete example of each recode in the image density database. Each record correlates the density values of the solid density patch P1 and the highlight density patch P2 with two manipulated variables. For instance, a record indicating the value of the grid voltage as ‘80’ and the value of the laser power as ‘60’ includes ‘1.48’ as the density value for the solid density patch P1, and ‘0.39’ as the density value for the highlight density patch P2.

The data of each record can apply data measured by means of a representative apparatus under typical environmental conditions. Prior to shipment of an actual apparatus, the data obtained by means of the representative apparatus is stored in the image density database 303 of the individual.

The reference pattern output value estimating unit 304 estimates values of the manipulated variables used when outputting the reference pattern. In the embodiment, the reference pattern output value estimating unit 304 estimates two sets of values of the two manipulated variables used when forming the solid density patch P1 and the highlight density patch P2 on the surface of the photosensitive drum 4. A set of values of the manipulated variables is for adjusting the density of the solid density patch P1 to the desired value of the solid density, of the patches P1 and P2 to be formed. Another set of values of the manipulated variables is for adjusting the density of the highlight density patch P2 to the desired value of the highlight density.

To estimate those values, the reference pattern output value estimating unit 304 obtains the values of the manipulated variables from the respective desired values of the patches P1 and P2 by means of the data stored in the image density database 303. Thought the representative apparatus that was used to configure the image density database 303 has an individual difference from the actual apparatus, the characteristic of the representative apparatus is essentially common to the actual apparatus. Accordingly, by obtaining the values of the manipulated variables from the desired density for the solid density patch P1 by means of the data stored in the image density database 303, it is possible to form the solid density patch P1 having the density approximate to the desired density. Also, by obtaining the values of the manipulated variables from the desired density for the highlight density patch P2, it is possible to form the highlight density patch P2 having the density approximate to the desired density.

The reference pattern output value estimating unit 304 obtains the desired density for respective patches P1 and P2 from the desired data storing unit 302. After obtaining the desired density, the reference pattern output value estimating unit 304 obtains the values of the manipulated variables correlated with each density value corresponding to the desired density, from the image density database 303.

On the image density database 303, there is not always only one record having the density values corresponding to the desired density. The reference pattern output value estimating unit 304 finds an appropriate record by means of the current set values of the manipulated variables. The current set values of the manipulated variables are stored in the set data storing unit 301, at the control of the image density.

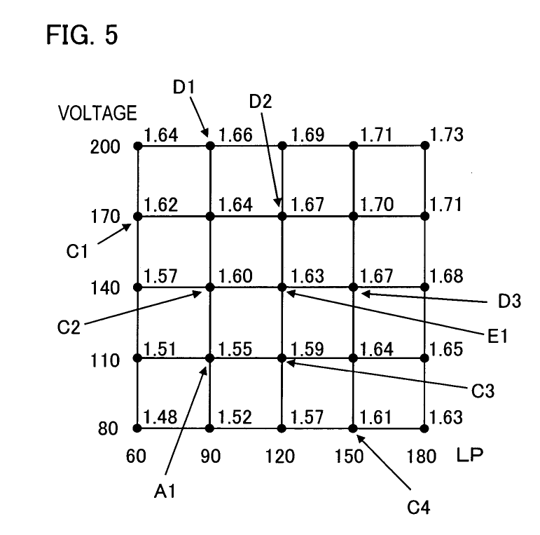

FIG. 5 is a diagram illustrating an example of density values for solid density patches stored in the image density database. In this figure, a numeric character at a right shoulder of each lattice point indicates the density value for the solid density patch P1 of the corresponding record. If the desired density for the solid density patch P1 is ‘1.60’, values of the records for four points C1 to C4 are near to the desired density. The other contents of FIG. 5 are the same as FIG. 4. The horizontal axis represents the laser power, and the vertical axis represents the grid voltage. If the current set value of the laser power is ‘90’ and the current set value of the grid voltage is ‘110’, the set values of the two manipulated variables is shown by a point A1 in FIG. 5. If the desired value and the values of the manipulated variables are like this, the reference pattern output value estimating unit 304 obtains the values of the manipulated variables from the record for the point C3.

In the embodiment, the reference pattern output unit estimating unit 304 obtains the values of the manipulated variables from the image density database 303 by preferentially changing the most dominant manipulated variable over the controlled variable among the manipulated variables. According to the result of the experiments, the laser power is more dominant over the solid density than the grid voltage. As changed the laser power, the density changes larger in a region of the solid density than in a region of the highlight density. On the contrary, the grid voltage is more dominant over the highlight density than the laser power. When controlling the density in plural regions, such as the solid density and the highlight density, if there is a parameter dominant over a specific density, this is very useful for the controllability.

As described above, the laser power of the two manipulated variables is the most dominant over the solid density. Therefore, when searching a record, the reference pattern output value estimating unit 304 gives a priority to a record having the value of the grid voltage not changed from the current set value and the value of the laser power different from the current set value. Of the four points C1 to C4, it is the point C3 that has the same value of grid voltage as the current set value.

Specifically, after obtaining the current set values of the manipulated variables, the reference pattern output value estimating unit 304 reads out the density value for the obtained values from the database 303. If the point Al represents the current set values of the manipulated variables, the reference pattern output value estimating unit 304 reads out ‘1.55’ as the density for the point A1 from the image density database 303.

After reading out the density value from the image density database 303, the reference pattern output value estimating unit 304 compares it with the detected value of the solid density patch P1 formed according to the current set values of the manipulated variables. If the actual detected value is ‘1.54’, the detected value is ‘0.01’ less than the density value read from the database 303. The difference represents the deviation between the current state, like the environmental conditions and the time availabilities, and the state at the time of obtaining the data from the image density database 303.

If a difference when the read value is subtracted from the actual detected value is not zero, the reference pattern output value estimating unit 304 estimates a correct desired density by adding the difference to the desired density obtained from the desired data storing unit 302. Instead of the desired density obtained from the desired data storing unit 302, the reference pattern output value estimating unit 304 obtains from the image density database 303 the values of the manipulated variables correlated with the density value corresponding to the correct desired density. As mentioned above, if the desired density is ‘1.60’ and the actual detected value is ‘0.01’ less than the readout value, the correct desired density is ‘1.59’. In this case, a record having the density value near to this correct desired density also corresponds to the four points C1 to C4. The reference pattern output value estimating unit 304 selects a record for the point C3, as mentioned above.

The reference pattern output value estimating unit 304 reads out values of the manipulated variables in the selected record, and then estimates values of the manipulated variables used when forming the solid density patch P1. The density value of the record for the point C3 is ‘1.59’, and it is identical with the above-mentioned correct desired density. When the correct desired density is identical with the density value of the record in this way, only referring the data of the record, the reference pattern output value estimating unit 304 can determine the values of the manipulated variables used when forming the solid density patch P1. From the record for the point C3, ‘120’ and ‘110’ are obtained respectively as the values of the laser power and the grid voltage.

In the above example, the record having the value of the grid voltage not different from the current set value is found. However, the record in which the value of the grid voltage is the same as the current set value sometimes does not have the density value for the desired density or the correct desired density. In such case, the reference pattern output value estimating unit 304 gives a priority to the record in which the difference between the value of the grid voltage and the current set value is small. For instance, when the desired density is ‘1.67’, and the current set values of the manipulated variables and the detected value for the set values are the same as the previous example, the correct desired density is ‘1.66’. The correct desired density is larger than ‘1.65’ that is the highest value when the grid voltage is not changed from the current set value. Accordingly, the record having the density value near to the correct desired density becomes records for three points D1 to D3. Of those records, the record wherein the difference between the value of the grid voltage and the current set value is the smallest is the record for the point D3.

The reference pattern output value estimating unit 304 compares the correct desired density with the density value read from the record for the point D3. The density value of the record for the point D3 is ‘1.67’, and the correct desired density is ‘1.66’, so that the correct desired density is ‘0.01’ less than the density value of the record. If the density value read from the record is not identical with the correct desired density like this, the reference pattern output value estimating unit 304 may estimate the values of the manipulated variables by the interpolation.

To estimate the values of the manipulated variables by the interpolation, the reference pattern output value estimating unit 304 finds, of the records of which the grid voltage is the same as the record for the point D3, a record with the density value near to the correct desired density and that is subordinated to the record for the point D3. In case of the example as shown in FIG. 5, the record with the density value near to the correct desired density and subordinated to the record for the point D3 is the record for a point E1. After finding out the record, the reference pattern output value estimating unit 304 reads the density value and the value of the laser power from not only the record for the point D3 but also the record for the point E1. The difference between the density values read from the both records is ‘0.04,’ and the difference between the values of the laser power is ‘300’. The difference between the correct desired density and the density value read from the record for the point E1 is ‘0.03.’ Based on those values, the reference pattern output value estimating unit 304 can calculate the value of the laser power for the correct desired density at ‘143’. Therefore, the reference pattern output value estimating unit 304 obtains ‘143’ and ‘140’ as the value of the laser power and the value of the grid voltage, respectively.

In this way, the reference pattern output value estimating unit 304 can estimate the values of manipulated variables for adjusting the density of the solid density patch P1 to the desired value of the solid density. The values of the manipulated variable for adjusting the density of the highlight density patch P2 to the desired value can be estimated in the same manner.

The detected data storing unit 305 stores data of the value detected by the density sensor 11. When the image forming unit 2 forms the solid density patch P1 and the highlight density patch P2 on the surface of photosensitive drum 4, the image density control unit 3 detects each density value of the patches P1 and P2 by means of the density sensor 11. The detected data storing unit 305 stores at least three sets of respective detected values of the patches P1 and P2 and the values of manipulated variables used when forming the patches P1 and P2. Two sets of those are data for the values of manipulated variables estimated by the reference pattern output value estimating unit 304. The other one set is data for the current set values of the manipulated variables. When estimating the values of the manipulated variables, the reference pattern output value estimating unit 304 obtains data for the current set values of the manipulated variables and the detected values for the respective patches P1 and P2 formed according to the set values from the detected data storing unit 305.

The manipulated variable calculating unit 306 calculates the set values of the manipulated variables used when outputting the image based on the input image signals, according to the detected values of the plural images of the reference pattern output by using the estimated values of manipulated variables and the desired value used when outputting each image. The manipulated variable calculating unit 306 performs the processing for obtaining the linearized output characteristic, according to the detected values of the plural images of the reference pattern and the manipulated values used when outputting each image.

In the image forming apparatus disclosed in Japanese Laid-open Publication No. 10-63048, the output characteristic of the apparatus is linearized by deciding the plane of the control case according to the three sets of the manipulated variables extracted based on the state variables.

As contrasted with that, the manipulated variable calculating unit 306 uses the values of manipulated variables estimated by the reference pattern output value estimating unit 304. When the solid density patch P1 and the highlight density patch P2 are formed according to the values of manipulated variables estimated by the reference pattern output value estimating unit 304, at least either one of the patch density becomes near to the desired value. According to the detected value of the density and the estimated values of the manipulated variables, each of the case planes for the solid density and the highlight density is decided. The manipulated variable calculating unit 306 finds the line of intersection of the case plane for the solid density and the plane for the desired density of the solid density, and the line of intersection of the case plane for the highlight density and the plane for the desired density of the highlight density. After finding the respective lines for the solid density and the highlight density, the manipulated variable calculating unit 306 decides a point of intersection of the two lines projected on the plane formed by plural manipulated variables, and calculates the set values of the manipulated variables for the desired value.

By materializing the above-mentioned functions according to the instructions of the control program 36, the image forming apparatus including the image density control unit 3 executes the following steps of the output image control method.

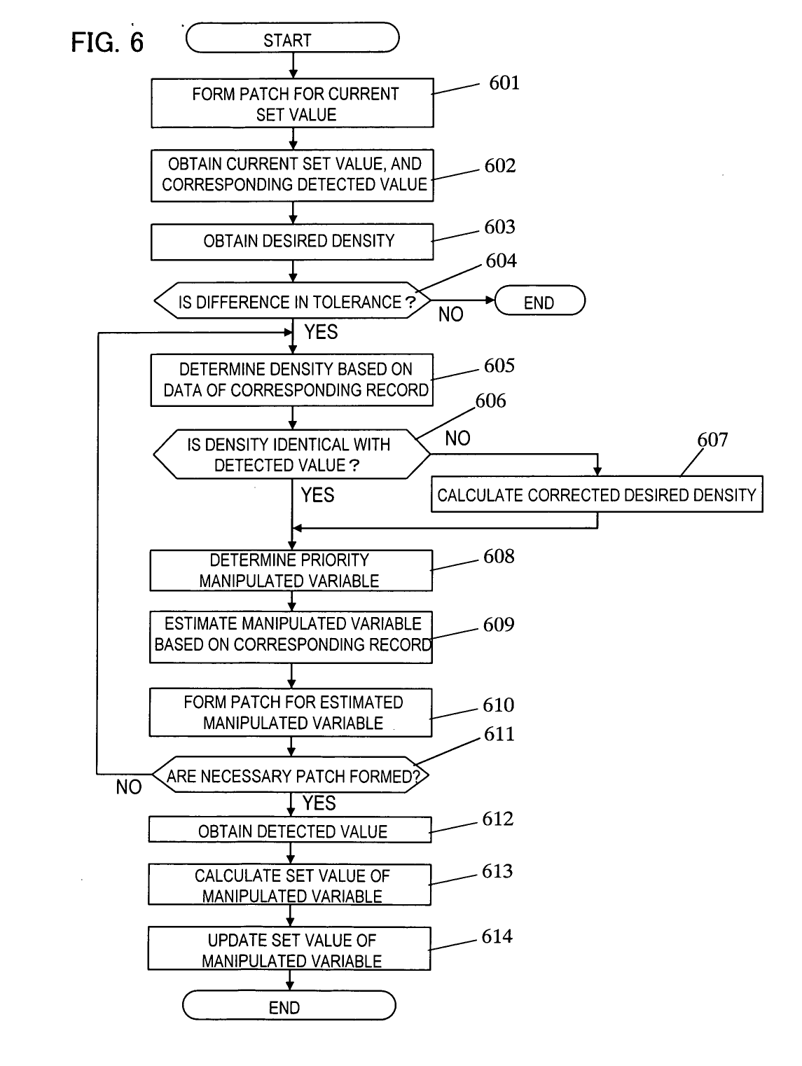

FIG. 6 is a flowchart for explaining the process of the output image control method in the embodiment. The image forming apparatus 1 starts the control according to an operator's instruction, a remote command, or a result of a self judgment. At the start of the control, the image forming apparatus 1 forms the solid density patch P1 and the highlight density patch P2 on the surface of the photosensitive drum 4 according to the current set values of the manipulated variables stored in the set data storing unit 301 (Step 601). After forming the patches P1 and P2, the image forming apparatus 1 detects each density of the patches P1 and P2 by the density sensor 11. When detecting the density of the patches P1 and P2, the image forming apparatus 1 stores the data of the current set values of the manipulated variables and the detected values on the detected data storing unit 305.

The image density control unit 3 obtains from the detected data storing unit 305 the current set values of the manipulated variables, and the data of the corresponding detected values (Step 602), and also obtains from the desired data storing unit 302 the data of the desired density for the respective patches P1 and P2 (Step 603).

Upon receipt of the data of the detected value and the desired density, the image density control unit 3 judges whether or not a difference between the detected value and the desired density is within its tolerance (Step 604). If the difference is acceptable, the image density control unit 3 terminates the control processing.

If not, the image density control unit 3 estimates the values of the manipulated variables for adjusting the density either for the solid density patch P1 or for the highlight density patch P2 to the desired density, and then estimates the values of the manipulated variables for adjusting the density of the other patch to the desired density. Here, at first, the values of the manipulated variables are estimated for adjusting the density of the solid density patch P1 to the desired. density.

The image density control unit 3 finds a record for the current set values of the manipulated variables from the image density database 303, and decides the density value according to the record data (Step 605). If the image density database has a record in which the values of the manipulated variables are identical with the set values, the density value for the solid density patch P1 is read from the record. If not, the density value is decided by the interpolation method by means of the data of four records.

After deciding the density value, the image density control unit 3 judges whether or not the density value decided according to the data on the image density database 303 is identical with the detected value for the solid density patch P1 (Step 606). If the decided density value is not identical with the detected value, the image density control unit 3 calculates the correct desired density (Step 607).

When the decided density value is identical with the detected value, or the correct desired density is calculated, the image density control unit 3 decides a priority manipulated variable (Step 608). In order to estimate the values of the manipulated variables for adjusting the density of the solid density patch P1 to the desired density, it decides as the priority manipulated variable the laser power of the grid voltage and the laser power, as mentioned before. For the values of the manipulated variables for adjusting the density of the highlight density patch P2 to the desired density, it decides the grid voltage the priority manipulated variable.

On deciding the priority manipulated variable, the image density control unit 3 selects one among the records for the desired density or the correct desired density, wherein the change of the priority manipulated variable becomes large while the change of the other manipulated variable becomes small. After selecting the record, the image density control unit reads the values of the manipulated variables from the data in the selected record to estimate the values of the manipulated variables for adjusting the density of the solid density patch P1 to the desired value (Step 609). If the density value for the solid density patch P1 in the selected record is identical with the desired density or the corrected desired density, the values of the manipulated variables can be decided only by reading the data from the record. If not identical, the values of the manipulated variables can be estimated by the interpolation.

Estimating the values of the manipulated variables, the image forming apparatus 1 forms the solid density patch P1 on the surface of the photosensitive drum 4 by means of the estimated manipulated variables (Step 610), and then detects the density of the formed solid density patch P1 by the sensor 11. After detecting the density of the formed solid density patch P1, the image forming apparatus 1 stores the data of the estimated values of the manipulated variables and the detected value in the detected data storing unit 305.

After the data is stored in the detected data storing unit 305 in such manner, the image density control unit 3 judges whether or not all the necessary patches are formed (Step 611). If only the patch for the desired value of the solid density is formed, the image forming apparatus 1 decides that all the necessary patches are not formed. In this case, the image forming apparatus 1 repeats from steps 605 to 611 in order to form the patch for the desired density of the highlight density.

Upon deciding that all the necessary patches are formed, the image density control unit 3 obtains the data for the current set values and the data for the estimated value from the detected data storing unit 305 (Step 612).

After obtaining the data from the detected data storing unit 305, the image density control unit 3 calculates the set values of the manipulated variables according to the obtained data from the detected data storing unit 305 and the data of the desired density for the respective patches P1 and P2 (Step 613).

The image density control unit 3 updates the set values of the manipulated variables by storing the estimated set values of the manipulated variables in the set data storing unit 301 (Step 614).

The case obtained by using thus formed patches is for predicting a point on a desired value realizing line which is the line of intersection of the control case plane and the desired density plane. By deciding the control case plane using the patches, it is possible to control the detachment between the control case plane and the characteristic of the actual apparatus. Accordingly, this makes it possible to perform the control of the image density more stably. Additionally, the change of the state has no influence upon the density control, so that the apparatus needs not to collect a number of control cases at the operation time.

The electrophotographic process is preferable to using two images of the reference pattern as above; one for adjusting the solid density patch P1 to the desired value, and the other for adjusting the highlight density patch P2 to the desired value. In the electrophotographic process, factors causing the change of the image density are correlated with each other complicatedly. Therefore, the characteristic of the change in a solid density region does not have necessarily any strong correlation with the characteristic of the change in a highlight density region. It is a general character that, if the surrounding environment has the high temperature or the high humidity, the image density will become high. Conversely, under the low temperature or the low humidity, the image density becomes low. However, there are other factors, such as the degradation of components and the degradation of the carrier. It is not always says that the different density regions have the same characteristic of the change. Therefore, it is desirable to use the two images of the reference pattern; one for adjusting the solid density patch P1 to the desired value and the other for adjusting the highlight density patch P2 to the desired value, as well as the image for the current set values.

In the above embodiment, two of the grid voltage of the charger 5 and the laser power of the laser output unit 6 are used as the manipulated variables, but those are not restricted to the above two. For example, a development bias of the developing unit 7 can be used as the manipulated variable in addition to those. In case of the two-component developing unit, the relation between a charged bias of the charger 5 and the development bias of the developing unit 7 has an influence upon the toner fog or the carrier jump. If the electric potential difference between the charged bias and the development bias is too small, it generates the fog phenomenon that the toners are attached to the whole printed surface. Contrarily, if the electric potential difference is too large, it generates the carrier jump that the carriers jump out from the developing unit 7. Therefore, if the development bias is fixed, the set range of the charged bias is decided naturally. Besides, in case of leaving a margin for considering the environmental change and the time deterioration, the set range is limited furthermore. By using both the charged bias and the development bias as the manipulated variables, such restriction can be eliminated.

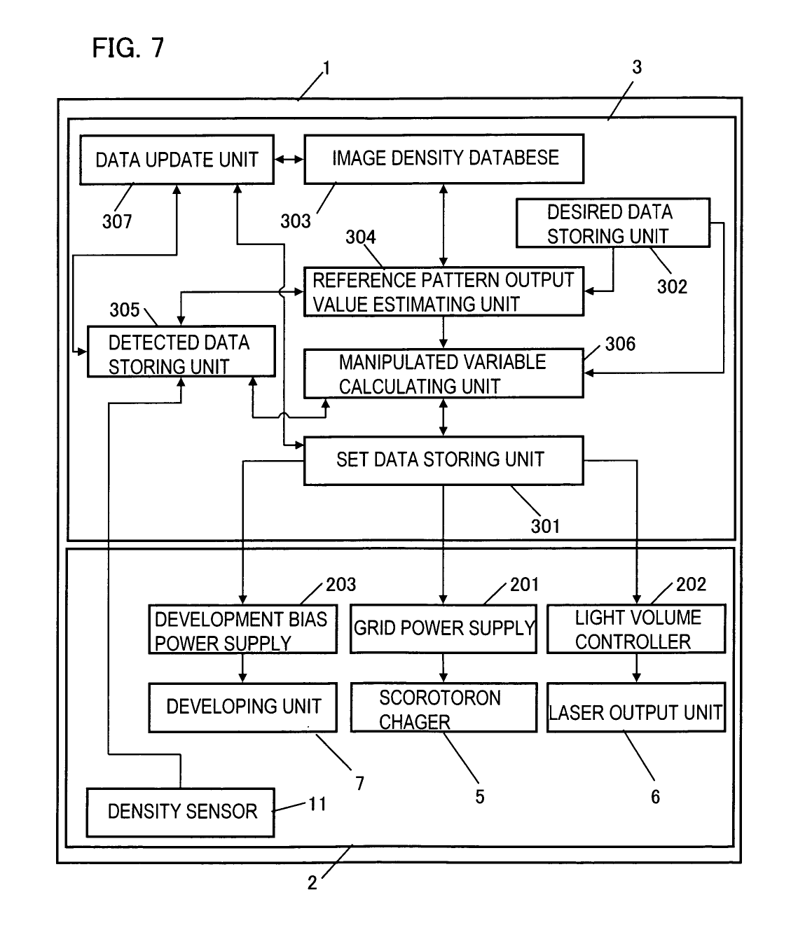

FIG. 7 is a functional block diagram for explaining the other configuration of the image forming apparatus in this embodiment. The image forming apparatus 1 is configured so that the set data storing unit 301 stores data for a set value of the development bias, in addition to the grid voltage of the charger 5 and the laser power of the laser output unit 6. A development bias power supply 203 reads the data for the set value of the development bias from the set data storing unit 301, and gives the development bias for the set value to the developing unit 7.

The development bias can be decided being associated with the charged bias. For example, by adding a predetermined electric potential difference to the development bias, the charged bias can be given. The manipulated variable calculating unit 306 calculates the grid voltage of the charger 5 as described above, and then can decide the development bias of the developing unit 7. While keeping the electric potential difference between the charged bias and the development bias constant, both the charged bias and the development bias are changed simultaneously, whereby the occurrence of the fog phenomenon and the carrier jump can be controlled. The image density database 303 contains the data that is assumed to change the development bias. Hence, it can eliminate the necessity for limiting the manipulation range of the grid voltage, in order to reduce the fog and control the carrier jump phenomenon, whereby the range can be set wide.

And the image forming apparatus 1 can be configured so that the image density control unit 3 further includes a data update unit 307. The data update unit 307 updates at any time the data on the image density database 303 according to the detected value for the image of the reference pattern output by using the values of the manipulated variables obtained from the image density database 303. The data update unit 307 may update the data immediately after the apparatus is powered on, or whenever the apparatus prints out the specific number of sheets.

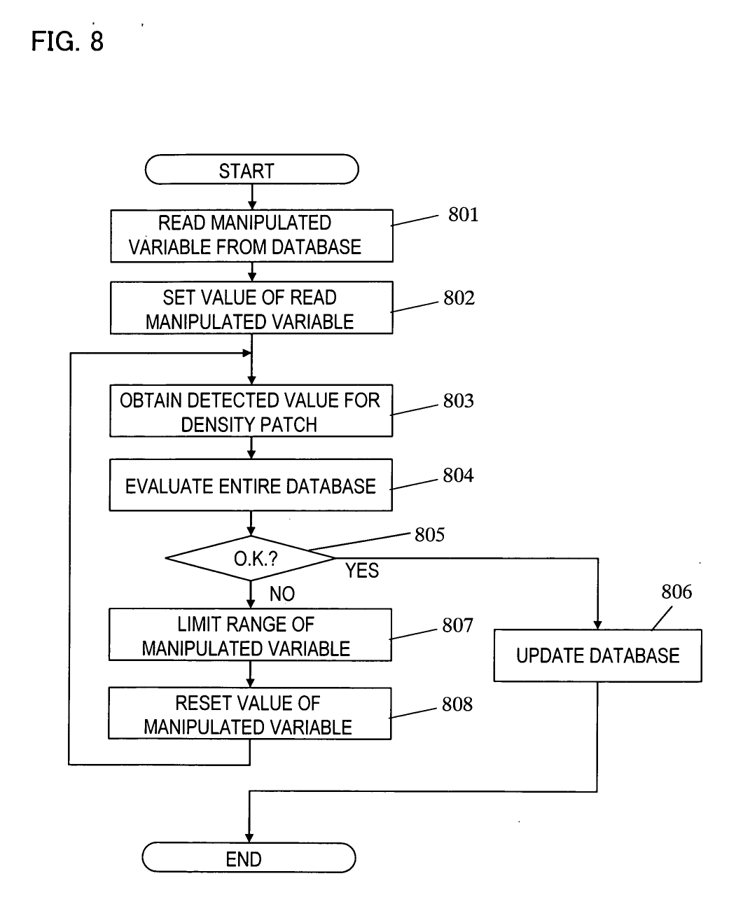

FIG. 8 is a flowchart for explaining the data update steps. For example, the data update unit 307 reads the values of the manipulated variables from each record on the image density database 303 (Step 801). After reading the values of the manipulated variables, the data update unit 307 stores the data of the read values in the set data storing unit 301 in sequence (Step 802). In addition to the data for the values read from each record on the image density database 303, the data for the values of the manipulated variables within the adjustable rage may be stored in the set data storing unit 301. In case of using the development bias as a manipulated variable, the valued found from the value of the grid voltage is stored in the set data storing unit 301 as the data for the development bias. The image forming unit 2 forms the density patch according to the data on the set data storing unit 301. When the density of the formed density patch is detected by the sensor 11, the data for the detected value of the density patch and the values of the manipulated variables used when forming the density patch are stored in the detected data storing unit 305. The data update unit 307 obtains the data from the detected data storing unit 305 (Step 803), and evaluates the planarity of the database when configuring the database by means of the obtained data (Step 804). For the evaluation, the data update unit 307 calculates a slope of the density at the time of changing the values of the two manipulated variables, for the solid density region and the highlight density region, for example.

The data update unit 307 judges whether or not the slope of the density within all the range of the given manipulated variables is within the tolerance (Step 805). If the slope of the density is within the tolerance, it can be considered that the density changes linearly over the region. In this case, a surface formed by the values of the two manipulated variables and the detected values is plane. If the surface was linearized, the difference would be very small. Where the slope of the density is within the tolerance, the data update unit 307 updates the data on the image density database 303 by storing the data of the detected data storing unit 305 in the image density database 303 (Step 806).

If the slope of the density is not within the tolerance, the data update unit 307 limits the set range of the manipulated variables so as to exclude a non-planar part (Step 807). A lower limit value may be predetermined to the set range of the manipulated variables. When the lower limit value is set, this limits the range of the manipulated variables to small. Due to the limitation of the set range of the manipulated variables, the data update unit 307 resets the values of the manipulated variables by storing in the set data storing unit 301 the values of the manipulated variables within the limited range (Step 808). Hence, the image forming unit 2 forms the density patches according to the reset values of the manipulated variables. The data update unit 307 repeats from Step 803 to Step 805 before the slope of the density for all the range of the set manipulated variables is set within the tolerance.

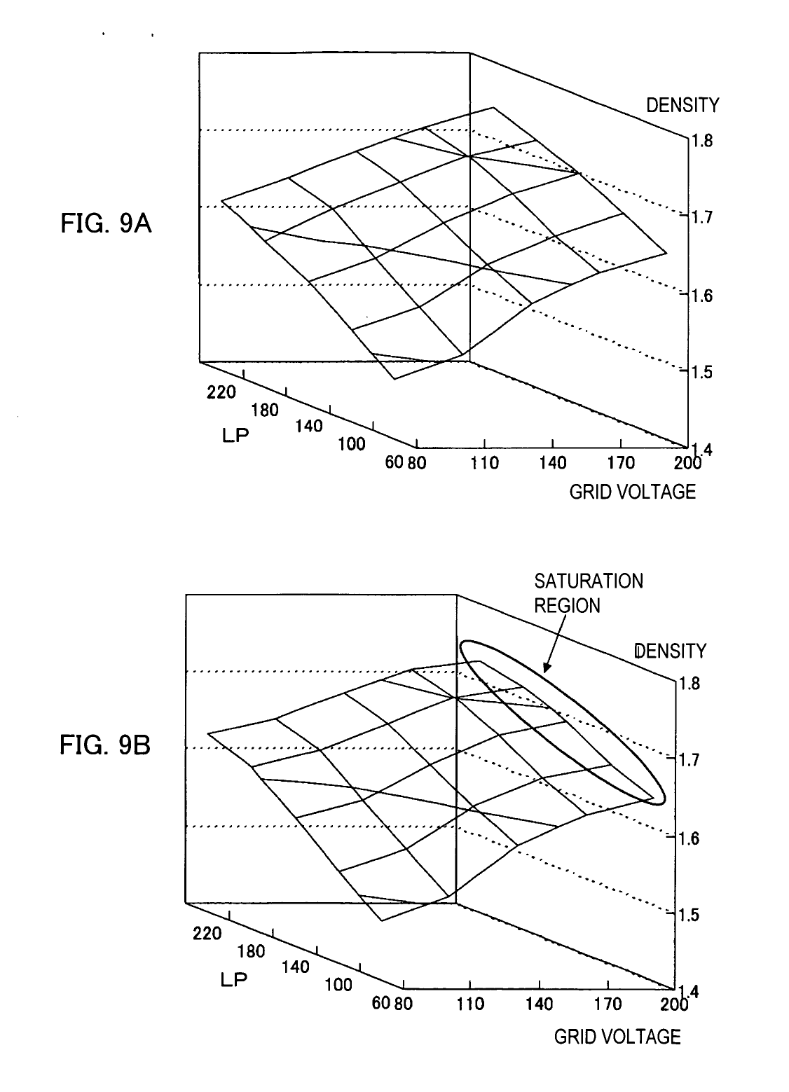

FIGS. 9A and 9B are diagrams for illustrating the planarity of the database. FIG. 9A shows an example of a plane indicated within the range of the given manipulated variables. An example shown in FIG. 9B include non-planar parts. In the example in FIG. 9B, the density is saturated in the regions wherein the laser power is large and the charged bias is small. On boundaries of the saturation regions, the slope of the density becomes large. If the slope of the density is not within the tolerance, the data update unit 307 diminishes the set range of the manipulated variables, in order to exclude the range for the saturation regions.

By changing the charged bias and the development bias together, with keeping a specific electric potential difference, the range of the manipulated variables can be set widely. It is also possible in such case to perform the stable control by securing the planarity of the database in advance.

Also, by updating the data of the image density database 303, it is possible to configure the database complied with the current state of the actual apparatus. The data is updated every time of printing the specific number of sheets as described above, whereby the influence of the time deterioration can be reflected on the database. If the data is updated when the state variables of the temperature and the humidity change extremely, the influence of the environmental change can be reflected on the database, too.

The cooperation of the charged bias and the development bias is effective even in case where the developing unit is a one-component developing unit. Even in the one-component developing unit having toner only therein, a very small amount of toner is charged with a polarity reverse to the normal one. The reverse polarity toner may generate the fog phenomenon depending on the electric potential difference between the charged bias and the development bias. Even in case of the one-component developing unit, the charged bias is associated with the development bias, whereby the occurrence of the fog phenomena can be controlled.

In the above-mentioned embodiment, the image density database 303 contains a plurality of records associating the value of the controlled variable with the values of the manipulated variables. Alternately, the image density database 303 may contain a plurality of records including data representing an equation for a relational between the manipulated variables and the controlled variable.

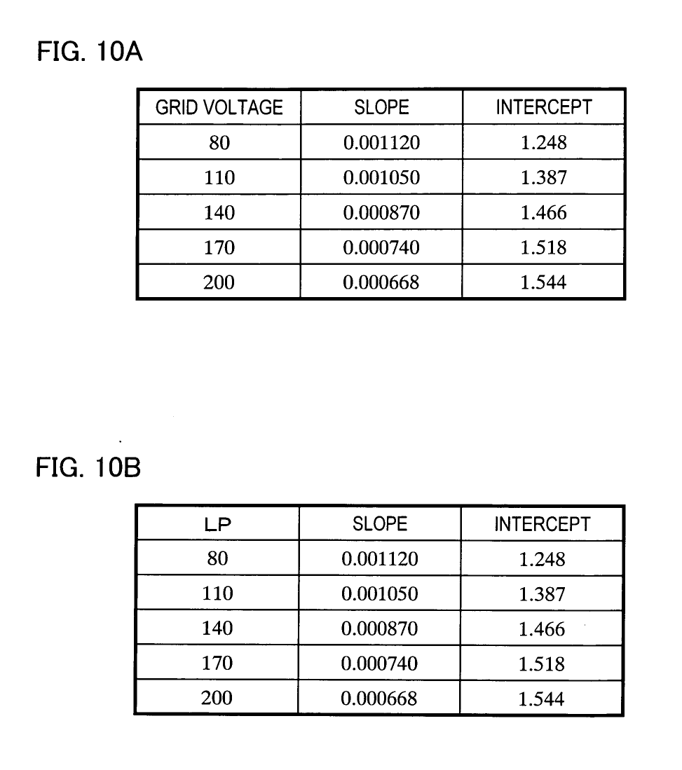

FIGS. 10A and 10B are diagrams for illustrating the other configuration example of the image density database. Each record of the image density database 303 gives the relation between the manipulated variables and the controlled variable by a linear equation. The records in FIG. 10A give relations between the laser power and the density. Each record correlates values of a slope and an intercept of the linear equation with the value of the grid voltage. Where the value of the laser power is ‘90’ and the value of the grid voltage is ‘170’, if using the record for the value of the grid voltage, the density can be calculated at 1.584 (=0.000740×90+1.518). Also, the records in FIG. 10B give relations between the grid voltage and the density. Each record correlates the values of the slope and the intercept of the linear equation with the value of the laser power. The record in FIG. 10A can be used when changing the value of the laser power, and the record in FIG. 10B can be used when changing the value of the grid voltage.

For example, provided that, where the value of the laser power is ‘90’ and the value of the grid voltage is ‘110’, the detected value for the solid density patch P1 is ‘1.55’ and the desired density is ‘1.62’. In this case, the difference between the detected value and the desired density is 0.07. When the detected value of the solid density patch P1 is adjusted to the desired density, the value of the laser power may be changed as mentioned above. To change the value of the laser power, the records in FIG. 10A are used. Where the value of the grid voltage is ‘110’, ‘0.001050’ can be found as the value of the slope from the corresponding record. To increase the detected value of the solid density patch P1 to the desired value, the value of the laser power may increase by ‘66.7’ (=0.07/0.00150). When the increment ‘66.7’ of the laser power is added to the current value ‘90’ of the laser power, ‘157’ can be found as the value of the laser power for adjusting the density of the solid density patch P1 to the desired density. According to such calculation, the reference pattern output value estimating unit 304 can obtain respective ‘157’ and ‘110’ as the values of the laser power and the grid voltage for adjusting the density of the solid density patch P1 to the desired value.

Moreover, if the calculated values are over the set range, the grid voltage is changed as well as the laser power. For instance, provided that the desired density for the solid density patch P1 is ‘1.65’ and the other conditions are the same as the above case. In this case, the difference between the detected value and the desired value is 0.1. To increase the detected value of the solid density patch P1 to the desired value, the value of the laser power must be increased by ‘95.2’ (=0.1/0.001050). Where the increment ‘95.2’ is added to the current value ‘90’ of the laser power, ‘185.2’ can be obtained as the value of the laser power for adjusting the density of the solid density patch P1 to the desired density. The value is over the set range of the laser power shown by the record in FIG. 10B.

In such case, the reference pattern output value estimating unit 304 increases the level of the value of the grid voltage for one level. The value of the laser power is left ‘90’ and the value of the grid voltage is changed from ‘110’ to ‘140’. The changed amount of the grid voltage is ‘30’. When the value of the laser power is ‘90’, ‘0.01540’ can be obtained as the value of the slope from the corresponding record in FIG. 10B. Therefore, where the value of the grid voltage is increased by ‘30’, it can be predicted that the density value increases by only ‘0.046’ (=30×0.001540) from ‘1.55’ which is the detected value. The difference between the predicted value ‘1.596’ (=1.55+0.0046) and the desired value is ‘0.054’ (=1.65−1.596). As shown by the record in FIG. 10A, when the value of the gird voltage is ‘140’, the value of the slope is ‘0.000870’. Therefore, to increase the detected value of the solid density patch P1 to the desired density, the laser power must be increased by ‘62.1’ (=0.054/0.000870). The increment ‘62.1’ of the laser power is added to the current value ‘90’ of the laser power, and then ‘152’ can be found as the value of the laser power for adjusting the density of the solid density patch P1 to the desired density. The reference pattern output value estimating unit 304 can obtain ‘152’ and ‘140’ as the values of the laser power and the grid voltage for adjusting the density of the solid density patch P1 to the desired density, respectively.

In case of using the record including the data representing the relational equation between the manipulated variables and the controlled variable as described above, it is also possible to estimate the values of the manipulated variables for adjusting the density of the solid density patch P1 to the desired density. The manipulated variables for adjusting the density of the highlight density patch P2 to the desired value can be also calculated in the same manner. The data of the value of the intercept may be excluded from each record. The above-mentioned calculation for the manipulated variables needs not the value of the intercept.

In the above embodiment, the reference pattern output value estimating unit 304 estimates the values of the manipulated variables for adjusting the density of the output image of the reference pattern to the desired density. Alternately, the reference pattern output value estimating unit 304 may perform a step for calculating the values of the manipulated variables predicted to be optimum for adjusting the detected value of the output image of the reference pattern to the desired value, and a step for obtaining the values of the manipulated variables near to the calculated optimum predicted values by using the data on the image density database 303.

When calculating the optimum predicted values, the reference pattern output value estimating unit 304 obtains from the detected data storing unit 305 the current set values of the manipulated variables and the detected values of the density when forming the solid density patch P1 and the highlight density patch P2 according to the set values. Furthermore, the data of the desired density for the respective patches P1 and P2 is also obtained from the desired data storing unit 302. After obtaining those values, the reference pattern output value estimating unit 304 calculates the correct desired density if necessary, as described above.

When calculating the correct desired density, if the image density database 303 has no record wherein the values of the manipulated variables are identical with the current set values, the density value for the current set values may be determined by the interpolation calculation for the data on the image density database 303.

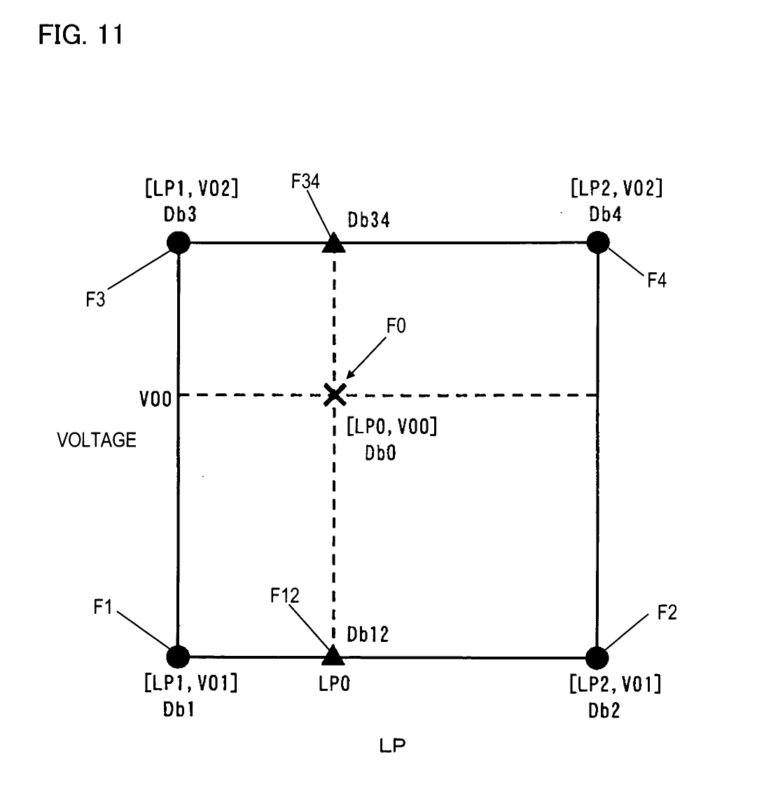

FIG. 11 is a diagram for illustrating the interpolation calculation of the density. In FIG. 11, the horizontal axis represents the laser power, and the vertical axis represents the grid voltage, like FIGS. 4 and 5. FIG. 11 represents a current set value of the laser power LP0 and a current set value of the grid voltage V00 as a point F0. Four points F1 to F4 correspond to the values of the manipulated variables in the records stored in the image density database 303. The density of each point Fn is represented by Dbn, and the values of the manipulated variables are represented by [LPn, V0n], respectively, (n: an integer from 0 to n). In the example shown in FIG. 11, the record in which the values of the manipulated variables are identical with the current set values does not exist on the image density database 303. In such case, to decide the density value Db0 for the current set values [LP0, V00], the reference pattern output value estimating unit 304 reads out the values of the manipulated variables from the records for the four points F1 to F4 around a point F0. After reading the values of the manipulated variables from each record, the reference pattern output value estimating unit 304 estimates the density values Db12 and Db34 for the points F12 and F13 respectively, according to following equations, for example.
Db12=(LP0−LP1)/(LP2−LP1)*(Db2−Db1)+Db1
Db34=(LP0−LP1)/(LP2−LP1)*(Db4−Db3)+Db3

After calculating the density values Db12 and Db34, the reference pattern output value estimating unit 304 calculates the density value Db0 using those values, according to a following equation.
Db0=(V00−V01)/(V02−V01)*(Db34−Db12)+Db12

The reference pattern output value estimating unit 304 can also calculate the correct desired density by applying the density values thus calculated.

After calculating the correct desired density if necessary, the reference pattern output value estimating unit 304 predicts the optimum values of the manipulated variables for adjusting the both density of the solid density patch P1 and the highlight density patch P2 to the respective desired density values by using the data on the image density database 303. The number of the sets of the values of the manipulated variables for adjusting one patch density to the desired density is not only one, and the sets forms a line on the plane formed by the laser power and the grid voltage. Here, the prediction line is specified by linear approximation.

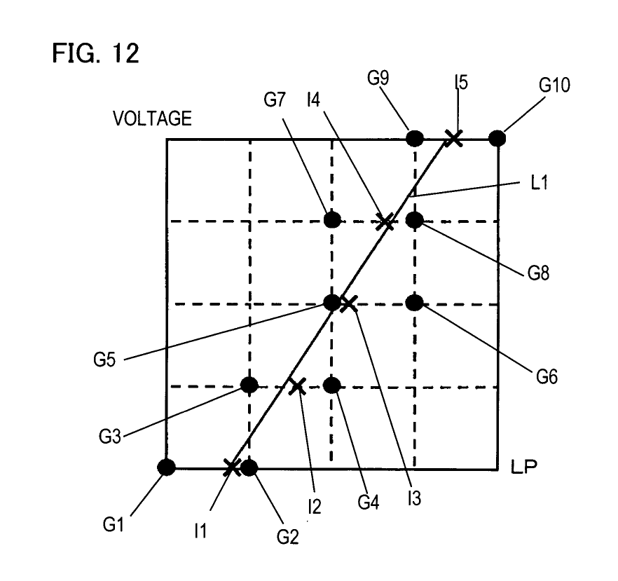

FIG. 12 is a diagram for illustrating the steps for specifying the prediction line. When specifying a prediction line L1 for the solid density patch P1, the reference pattern output value estimating unit 304 obtains the values of the manipulated variables for every value of the grid voltage, from the data in the image density database 303. Of the records having the same value of the grid voltage, the reference pattern output value estimating unit 304 specifies two records near to the desired density or the corrected desired density. One record is the nearest one of the records having a value not less than the desired density or the corrected density. The other record is the nearest one of the records having a value not more than the desired density or the corrected density. The specified records correspond to any points of points G1 to G10 in FIG. 12. After specifying the two records, the reference pattern output value estimating unit 304 reads out the data for the value of the laser power and the density value from the two records. The value of the laser power for the desired density or the corrected desired density is calculated using the read-out value by the interpolation. The reference pattern output value estimating unit 304 performs the calculation for every value of the grid voltage, and finds a plurality of sets of the values of the manipulated variables for the desired density or the corrected desired density. The obtained values of the manipulated variables correspond to the points I1 to I5 in FIG. 12. The reference pattern output value estimating unit 304 specifies the straight line L1, wherein the respective differences from those points becomes the minimum, by the method of least squares. Specifying the prediction line for the solid density patch P1, the reference pattern output value estimating unit 304 specifies the prediction line for the highlight density patch P2 in the same manner.

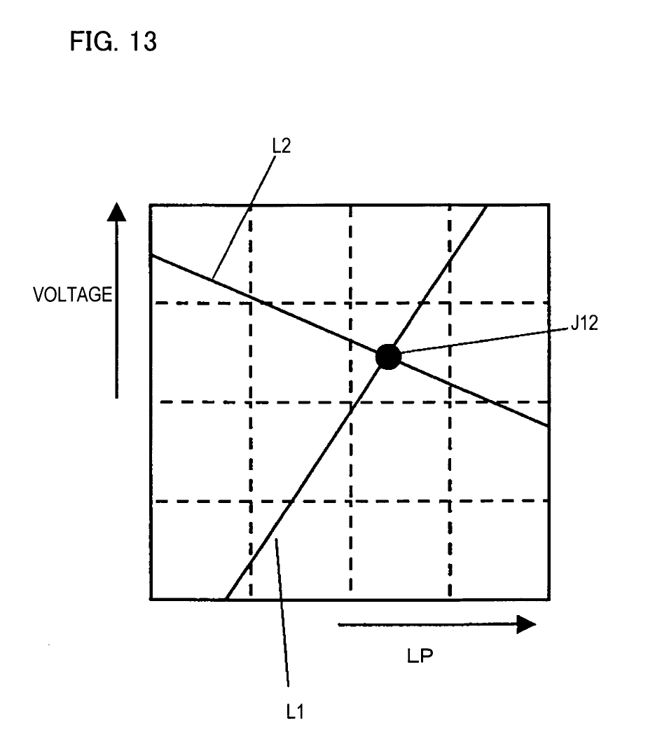

FIG. 13 is a diagram for illustrating the relation between the prediction line and the optimum predicted values. A point J12 for the optimum predicted values is a point of intersection of the prediction line L1 for the solid density patch P1 and the prediction line L2 for the highlight density patch P2. By finding the point, the reference pattern output value estimating unit 304 calculates the optimum predicted values for adjusting both the density of the solid density patch P1 and the highlight density patch P2 to the respective desired density values.

After finding the optimum predicted values, the reference pattern output value estimating unit 304 obtains three sets of values of the manipulated variables near to the calculated optimum predicted Values by means of the data on the image density database 303. The three sets of the near values would be selected so as not to be unevenly distributed. The uneven distribution can be estimated by the position relation between respective near values, or by the angles among lines joining the respective near values and the optimum predicted values. Whether or not the values are the near values can be judged from a distance from the optimum predicted value.

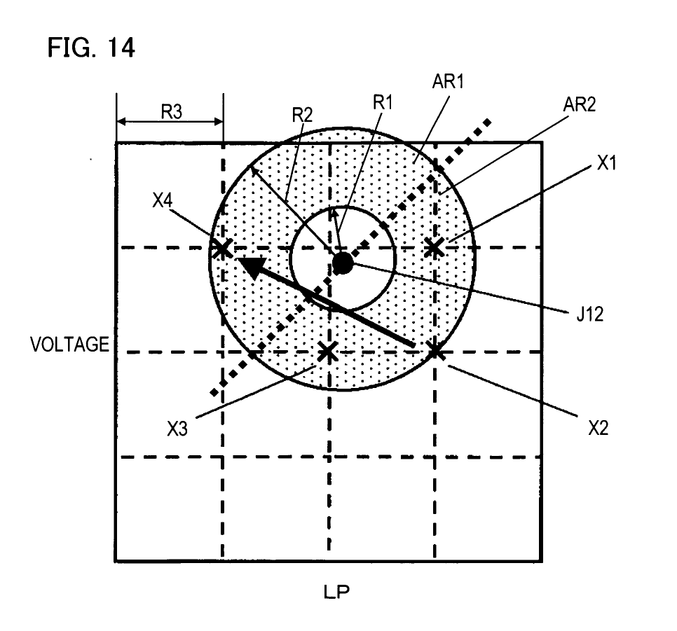

FIG. 14 is a diagram for illustrating the relation between the optimum predicted values and the near values. In FIG. 14, the point J12 corresponds to the optimum predicted values, and the points X1 to X4 correspond to the values of the manipulated variables in the records on the image density database 303. The reference pattern output value estimating unit 304 selects three points corresponding to the near values from an area AR1 of which distance from the point J12 is longer than the length of an arrow R1 and shorter than the length of an arrow R2. When a minimum interval of the manipulated variables given by each record is R3, the length of the arrow R1 can be given by 0.5×R3, for example. Also, the length of the arrow R2 can be given by 1.2×R3. Even when three points are within the area AR1, if those points are unevenly distributed, the reference pattern output value estimating unit 304 repeats the selection. When the points X1 to X3 are selected, the reference pattern output values estimating unit 304 decides that those points are unevenly distributed. Here, the decision is made based on whether or not the all the three points are in a half circle. In case of the points X1 to X3, all the points X1 to X3 are in the half circle AR2, so that the reference pattern output value estimating unit 304 decides that those points are unevenly distributed, and then change the selected points. In this case, a point X4 in another half circle is selected instead of the point X2.

Instead of selecting the points corresponding to the near values from the points X1 to X4 corresponding to the values of the manipulated variables in the records as described above, the near point may be determined by a calculation using the data in records. Also, angles among lines joining the near values and the optimum predicted values are preferable to an approximate 120 degree. The manipulated variable calculating unit 306 calculates the set values of the manipulated variables using the three sets of the near values.

In order to carry out such functions of the reference pattern output value estimating unit 304 and the manipulated variable calculating unit 306, the image forming apparatus 1 executes steps different partially from the steps 601 to 604 mentioned above.

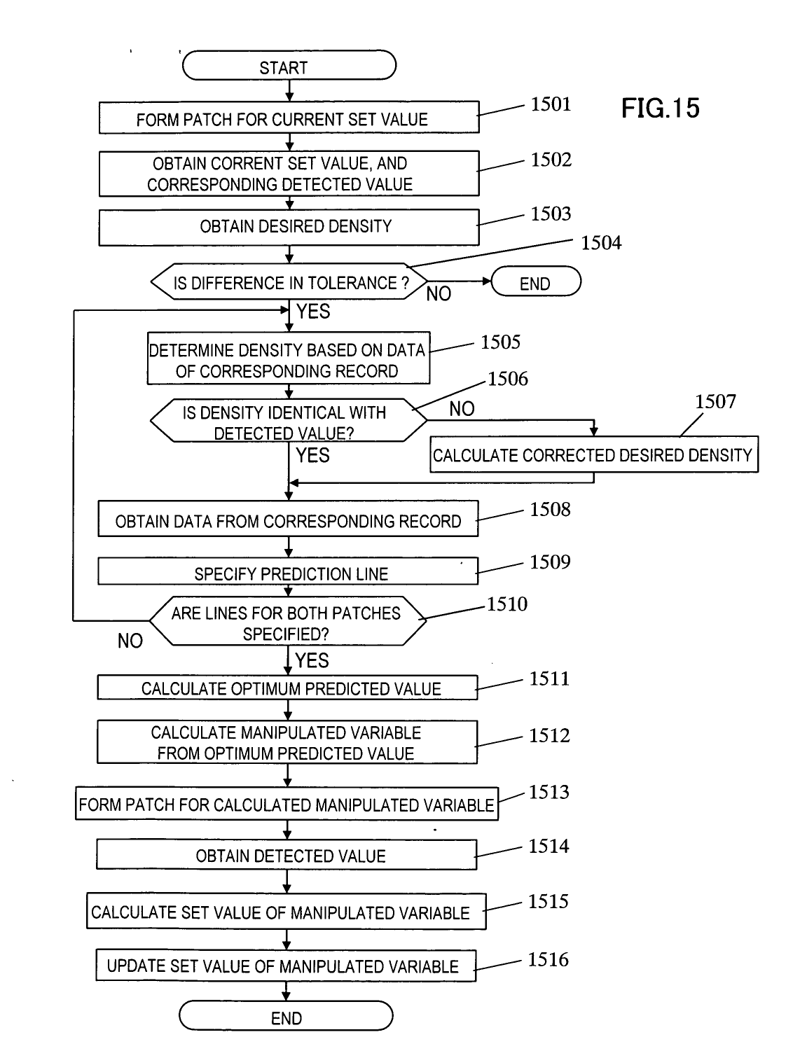

FIG. 15 is a flowchart for explaining another example of steps of the image output control method in this embodiment. When the set values of the manipulated variables are calculated by using the three sets of the near values, the image forming apparatus 1 executes steps 1501 to 1516. The steps 1501 to 1507 are the same as the steps 601 to 607 in FIG. 6. After calculating the correct desired density if necessary (Step 1507), the image density control unit 3 obtains the data for the record corresponding to the desired density or the correct desired density from the density database 303 (Step 1508). The image density control unit 3, using the obtained data, specifies the prediction line for the solid density patch P1 or the highlight density patch P2 (Step 1509). When specifying the prediction line for the solid density patch P1 or the highlight density patch P2, the image density control 3 judges whether or not the respective prediction lines are specified for the both patches P1 and P2 (Step 1510). If the prediction line only for one patch is specified, the image density control unit 3 repeats the steps 1505 to 1509 to specify the prediction line for another patch. After specifying the prediction lines for the both patches P1 and P2, the image density control unit 3 calculates the optimum predicted values by finding a point of intersection of the two prediction lines (Step 1511). The image density control unit 3 calculates three sets of the near values for the calculated optimum predicted values (Step 1512). Calculating the near values, the image forming apparatus 1 forms the solid density patch P1 and the highlight density patch P2 according to the respective near values (Step 1513). The image forming apparatus 1 detects the density of each patch P1 and P2 by the density sensor 11, and stores in the detected value data storing unit 305 the data of the near values and the detected values of the patches P1 and P2 formed according to the near values. The image density control unit 3 obtains the data for the near values and the detected values for the near values from the detected data storing unit 305 (Step 1514). The image density control unit 3, using the data obtained from the detected data storing unit 305, calculates new set values of the manipulated variables (Step 1515). Upon calculating the set values of the manipulated variables, the image density control unit 3 updates the set values of the manipulated variables by storing the values in the set data storing unit 301 (Step 1516).

The near values obtained according to the above-mentioned steps is fairly close to the values of the manipulated variables for adjusting the density of the solid density patch P1 and the highlight density patch P2 to the respective desired density values. Therefore, in case of deciding the control case plane by using the near values, it is possible to control the difference with the original characteristics around the near values of the apparatus. Accordingly, this makes it possible to perform more stable control of the image density. Additionally, the apparatus is not influenced by the change of the state, so that the necessity of collecting a number of control cases can be eliminated.

The reference pattern output value estimating unit 304 may determine two sets of the near values instead of the three sets of the near values. In this case, the manipulated variable calculating unit 306 can use the current set values of the manipulated variables read from the detected data storing unit 305, in addition to the two sets of the near values. By using the current set values of the manipulated variables instead of the one set of the near values, it is possible to reduce one image to be formed for the reference patterns. In result, it is possible to reduce the time for forming and detecting the density patches. The control of the density can be terminated in a shorter time than ever.

In the above-mentioned respective embodiments, the interpolation calculation or the linearization is assumed on that the density changes linearly for the change of the manipulated variables. Instead of the linearization, the approximation may be performed by the other methods. For example, it may be approximated by the polygonal lines along with the characteristic of the image density change, or by the high-order curve.

When the set values of the manipulated variables are calculated in the above-mentioned manner, the set values are represented by consecutive values. Mathematically, there is no problem in controlling the image density by using the values. However, practically, there is possibility that an input value to the grid power supply 201 or the light volume controller 202 is limited to some levels of discrete values. In such case, the set values may be quantized in a specific width corresponding to the resolution of the grid power supply 201 or the light volume controller 202. The quantization width is determined linearly, or determined adaptively according to the characteristic.

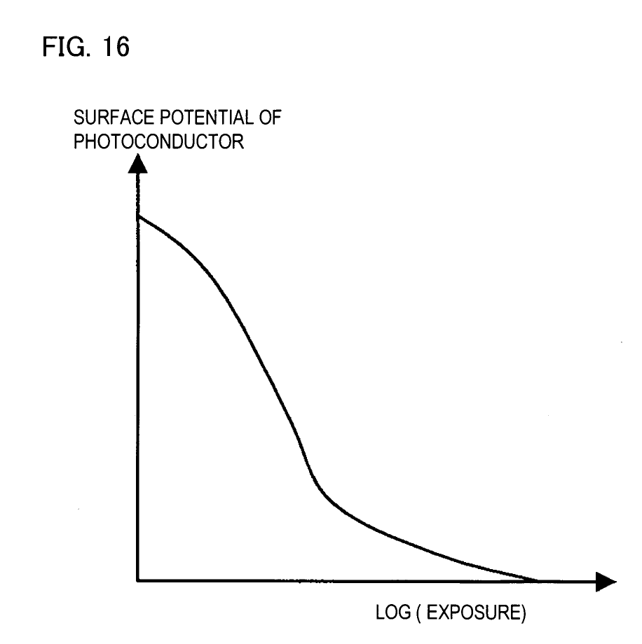

FIG. 16 illustrates an example of the potential damping characteristic of the photoconductor. The density for the voltage value, such as the charged bias and the development bias, has a characteristic comparatively approximate to be linear. On the other hand, the density for the exposure light volume depends heavily on the potential damping characteristic of the photoconductor. As shown in FIG. 16, the surface potential of the photoconductor decreases suddenly till the exposure reaches a specific value, and from there decreases gradually. In case of using only a part where the slope is approximately constant, of such characteristic, the quantization width can be fixed. However, when the slope of the utilized part changes largely, the quantization width should be changed according to the slope. For example, the quantization width may be small in the part with a steep slope, while the quantization width may be large in the part with a gentle slope. By determining adaptively the quantization width according to the characteristic, it is possible to improve the dynamic range or the resolution for the image density.

The data for the manipulated variables on the image density database 303 can be prepared at intervals corresponding to the output characteristic of the apparatus, instead of being prepared at regular intervals. Like the quantization width, the data for the manipulated variables are prepared in small intervals for the part with the steep slope of the characteristic, and in large intervals for the part with the gentle slope of the characteristic. By setting the intervals of data of the manipulated variables according to the characteristic, it is possible to improve the accuracy of the density control and broaden the configurable range.

In the above embodiments, the invention is applied to the apparatus forming a monochromatic image, but it is not limited to this. The invention can be applied to the apparatus forming a color image. For the color image, if the density for even one color gets unstable, it influences upon the hue at the superposition. Therefore, when forming the color image, the above-mentioned control is essential to the stabilization of the density. In the tandem type of image forming apparatus in which the image forming units for each color of yellow, cyan, magenta, and black are aligned, it is possible to control the density of the toner images of respective colors in the same way as described above. When the tandem type of image forming apparatus comprises an intermediate transfer unit for overlaying the toner images for respective colors, it may be configured so as to detect the density of the toner image on the intermediate transfer unit. In this case, the density sensor needs not to be provided for each color. By reducing the number of the density sensors, the cost can be reduced, too.

In addition to the grid voltage of the scorotron charger 5, the laser power of the laser output unit 6, and the development bias of the developing unit 7, a pulse width of the image signal to input in the laser output unit 6 and the other factors concerned with the density can be used as the manipulated variables. The number of the manipulated variables may be three and more.

It may be configured so as to control the density formed on an output medium like a paper, instead of controlling the density of the toner image. In this case, the image forming unit 2 is provided with a sensor for detecting the density of the fixed image, as a detecting unit for detecting the controlled variable of the output image.

Also, the controlled variable is not limited to the image density. The other volume related to the image quality, such as the brightness, the hue, and the glossiness, can be controlled in the above-mentioned manner.

In the above embodiments, the invention is applied to the electrophotographic type of image forming apparatus, but the invention is not limited to this. The invention can be applied to the other type of image forming apparatus such as an inkjet printer, or an image display device like a display. The invention also can be applied to a system in which a computer is connected with the image forming apparatus or the image display device.

The control program 36 utilized in the above embodiments can be provided to a person concerned or a third party by using an telecommunications line such as the Internet, or by stored it on a computer-readable storage medium. For example, the instructions of the program are represented by electric signals, optical signals, or magnetic signals, and the signals are transmitted on carrier waves, whereby the program can be provided through a transmission medium such as a coaxial cable, a copper wire, and an optical fiber. As the computer-readable storage medium, it is possible to use an optical medium like CD-ROM or DVD-ROM, a magnetic medium like a flexible disk, a semiconductor memory like a flash memory or RAM.

The image output apparatus, the output image control method, and the output image control program of the invention can control the output image stably without collecting a number of control cases at the operation time of the image output apparatus, and those are useful for the electrophotographic type and the inkjet type of image forming apparatus, or the other type of image output apparatus.

Although only some exemplary embodiments of this invention have been described in detail above, those skilled in the art will readily appreciated that may modifications are possible in the exemplary embodiments without materially departing from the novel teachings and advantages of this invention. Accordingly, all such modifications are intended to be included within the scope of the invention.

The discloser of Japanese Patent Application No. 2004-184739 filed Jun. 23, 2004 and No. 2004-362641 filed Dec. 15, 2004 including specification, drawings and claims is incorporated herein by reference in its entirely.

1. An image output apparatus, comprising
an image output unit configured to output an image according to values of manipulated variables;
a detecting unit configured to detect a controlled variable of an output image of a reference pattern;
a data storing unit configured to store data giving a relation between the controlled variable and the manipulated variables for the reference pattern;
a reference pattern output value estimating unit configured to estimate sets of values of the manipulated variables used when outputting images of the reference pattern, by using the data on the data storing unit to obtain values of the manipulated variables from a desired value for the reference pattern; and
a manipulated variable calculating unit configured to calculate set values of the manipulated variables for the desired value, according to the detected values for a plurality of images of the reference pattern outputted by using the sets of the estimated values of the manipulated variables.

2. The image output apparatus of claim 1, wherein the manipulated variable calculating unit obtains a linearized output characteristic according to the detected values for the plurality of images of the reference pattern and the values of the manipulated variables used when outputting respective images, and calculates the set values of the manipulated variables for the desired value, according to the linearized output characteristic.

3. The image output apparatus of claim 1, wherein the reference pattern output value estimating unit obtains the values of the manipulated variables using the data on the data storing unit, by changing values of the most dominant manipulated variable over the controlled variable, of the manipulated variables.

4. The image output apparatus of claim 1, wherein the reference pattern output value estimating unit estimates the values of the manipulated variables used when outputting the image of the reference pattern, according to the set values of the manipulated variables and the values of the manipulated variables related to the controlled variable for the desired value.

5. The image output apparatus of claim 1, wherein the data storing unit is a database containing a plurality of records relating the value of the controlled variable to the values of the manipulated variables; and
the reference pattern output value estimating unit estimates the values of the manipulated variables used when outputting the image of the reference pattern, by obtaining the values of the manipulated variables related to the value of the controlled variable for the desired value, from the data on the database.

6. The image output apparatus of claim 1, further comprising:
a data update unit configured to update the data on the data storing unit, according to the detected value for the image of the reference pattern outputted according to the values of the manipulated variables obtained from the database.

7. The image output apparatus of claim 6, wherein the data update unit sets a range of the manipulated variables, according to an approximate difference when the relation between the controlled variable and the manipulated variables is linearized.

8. The image output apparatus of claim 1, wherein the reference pattern output value estimating unit calculates values of the manipulated variables predicted to be the optimum for adjusting the detected value for the output image of the reference pattern to the desired value, and obtains values of the manipulated variables near to the calculated optimum predicted value by using the data on the data storing unit.

9. The image output apparatus of claim 8, wherein the manipulated variable calculating unit calculates the set values of the manipulated variables for the desired value, according to the detected values for the plurality of images of the reference pattern outputted according to the set values of the manipulated variables and the values of the manipulated variables near to the optimum predicted value.

10. An image forming apparatus, comprising:
a charger configured to charge a surface of a photoconductor uniformly;
a laser output unit configured to form an electrostatic latent image on the surface of the photoconductor according to an image signal, by exposing the uniformly charged surface of the photoconductor;
a developing unit configured to form a toner image on the surface of the photoconductor, by developing the electrostatic latent image on the surface of the photoconductor with toner;
a sensor configured to detect density of the toner image of a reference pattern formed on the surface of the photoconductor;
a database configured to store data giving a relation between input values to the charger and the laser output unit and a value of the density for the reference pattern;
a reference pattern output value estimating unit configured to estimate sets of input values to the charger and the laser output unit used when forming toner images of the reference pattern, according to a desired value of the density for the referenced pattern and the data on the database; and
a manipulated variable calculating unit configured to calculate set values of the input values to the charger and the laser output unit used when forming the image, according to the detected values for the toner images of the reference pattern formed by the estimated input values to the charger and the laser power, and the desired value.

11. The image forming apparatus of claim 10, wherein the manipulated variable calculating unit calculates the input value to the developing unit according to the input value to the charger.

12. The image forming apparatus of claim 11, wherein the reference pattern output value estimating unit estimates at least two sets of the input values to the charger and the laser output unit used when forming a solid density patch and a highlight density patch, according to the desired values of the density for respective the solid density patch and the highlight density patch.

13. The image forming apparatus of claim 12, wherein the reference pattern output value estimating unit selects the input value to the laser output unit as a preferentially changed value when obtaining the input values to the charger and the laser output unit from the desired value of the density for the solid density patch, and selects the input value to the charger as a preferentially changed value when obtaining the input values to the charger and the laser output unit from the desired value of the density for the highlight density patch.

14. The image forming apparatus of claim 12, wherein the reference pattern output value estimating unit specifies a prediction line formed by predicted values of the manipulated variables for adjusting the density of the solid density patch to a desired density for the solid density patch, specifies a prediction line formed by predicted values of the manipulated variables for adjusting the density of the highlight density patch to a desired density for the highlight density patch, and estimates the input values to the charger and the laser output unit used when forming the solid density patch and the highlight density patch by using the respective prediction lines for the solid density patch and the highlight density patch.

15. The image forming apparatus of claim 14, wherein the reference pattern output value estimating unit estimates the input values to the charger and the laser output unit used when forming the solid density patch and the highlight density patch, by using the respective prediction lines for the solid density patch and the highlight density patch to calculate values of the manipulated variables predicted to be the optimum for adjusting the density of the solid density patch to the desired density of the solid density patch as well as adjusting the density of the solid density patch to the desired density for the solid density patch, and obtaining the values of the manipulated variables near to the calculated optimum predicted value using the data on the database.

16. An output image control method controlling an output image by using a reference pattern, comprising the steps of:
calculating sets of values of manipulated variables used when outputting an image of the reference pattern, by obtaining values of the manipulated variables from a desired value for the reference pattern using data on data storing unit storing the data giving a relation between the controlled variable and the manipulated variables for the reference pattern;
outputting a plurality of images of the reference pattern according to the estimated values of the manipulated variables; and
calculating set values of the manipulated variables for the desired density according to the detected value for the controlled variable of the output image of the reference pattern.

17. An output image control program for causing an image output apparatus to perform the steps of the output image control method of claim 16.

18. A machine readable medium bearing instructions of a program for controlling an output image, said instructions arranged to cause an image output apparatus to perform the steps of the output image control method of claim 16.
